(19) United States
(12) Patent Application Publication
(10) Pub. No.: US 2016/0103823 A1
(43) Pub. Date: Apr. 14, 2016

(54) Machine Learning Extraction of Free-Form Textual Rules and Provisions From Legal Documents

(71) Applicant: The Trustees of Columbia University in the City of New York, New York, NY (US)

(72) Inventors: Robert J. Jackson, JR., New York, NY (US); Joshua R. Mitts, Jersey City, NJ (US)

(73) Assignee: The Trustees of Columbia University in the City of New York, New York, NY (US)

(21) Appl. No.: 14/879,369

(22) Filed: Oct. 9, 2015

Related U.S. Application Data
(60) Provisional application No. 62/062,472, filed on Oct. 10, 2014.

(51) Int. Cl. G06F 17/27; G06F 17/28

(52) U.S. Cl. CPC G06F 17/274; G06F 17/2785; G06F 17/28

(57) ABSTRACT

Disclosed herein is a system and method for machine learning extraction of free-form textual rules and provisions from legal documents. The method comprising electronically receiving, by the legal rules extraction engine, a document, processing the document using a first trained model executed by the legal rules extraction engine to classify the document into a document class, processing the document using a second trained model executed by the legal rules extraction engine to extract rules within the document conditional on the document class identified by the first trained model, extracting a plurality of data variables from the document by processing the classified features in the document using a third trained model executed by the legal rules extraction engine, generating by the legal rules extraction engine an output vector based on the plurality of data variables, and displaying the output vector by the legal rules extraction engine at the user interface.

### CROSS-REFERENCE TO RELATED APPLICATIONS

This application claims the benefit of U.S. Provisional Application Ser. No. 62/062,472 filed on Oct. 10, 2014, the entire disclosure of which is expressly incorporated herein by reference.

### BACKGROUND

The present disclosure relates generally to a system and method for extraction of textual rules and provisions. More specifically, the present disclosure relates to a system and method for extraction of textual rules and provisions from legal documents.

Expedient identification and processing of rules and provisions found in legal documents is of considerable importance in the financial, corporate and legal realms. Manual extraction of the rules and provisions by legal professionals can contribute to increase service fees and inefficiency. While software for summarization of legal documents or interpretation of their general linguistic logic does exist, it cannot effectively extract substantive rules or provisions required to impose structure upon large sets of documents. Therefore, needed is a system and method for machine learning extraction of free-form textual rules and provisions from legal documents.

### SUMMARY

The present disclosure relates to a system and method for autonomously extracting textual rules and provisions from legal documents by a computer system. As such, provided is a supervised computer system and method that utilizes detailed, domain-specific substantive knowledge of different types of legal documents to generate structured datasets of substantively meaningful rules and provisions.

### BRIEF DESCRIPTION OF THE DRAWINGS

The foregoing features of the invention will be apparent from the following Detailed Description of the Invention, taken in connection with the accompanying drawings, in which:

FIG. 1 is diagram showing a process executed by a legal rule extraction engine for extracting free-form textual rules and provisions from legal documents;

FIG. 2 is another diagram showing a process executed by the legal rule extraction engine for extracting free-form textual rules and provisions from legal documents;

FIG. 3 is a diagram showing inputs, outputs, and components of the legal rule extraction engine; and

FIG. 4 is a diagram showing sample hardware components for implementing the present invention.

### DETAILED DESCRIPTION

The present invention relates to a system and method for machine learning extraction of free-form textual rules and provisions from legal documents. The system and method apply statistical machine learning and natural language processing to electronically extract free-form textual rules and provisions from legal documents, and transform vast quantities of unstructured text into structured datasets of these rules and provisions. All types of legal documents are contemplated, such as contracts, corporate documents, security filings, etc. Unlike previous methods utilizing natural language processing with legal documents, in the disclosed system and method, a legal rule extraction engine employs substantive legal knowledge to apply supervised machine learning in the information extraction process. Thus, rather than attempting to generically model the logic of legal language, which has proven to be a largely insurmountable challenge in the natural language literature, the legal rule extraction engine exploits detailed, domain specific substantive knowledge along with supervised classifier to extract a defined set of legal rules and terms. Accordingly, the present disclosure provides an improvement in the quality and speed of computer extraction of textual rules and provisions from legal documents. The present disclosure provides the elements necessary for a computer to effectively extract textual rules and provisions from legal documents.

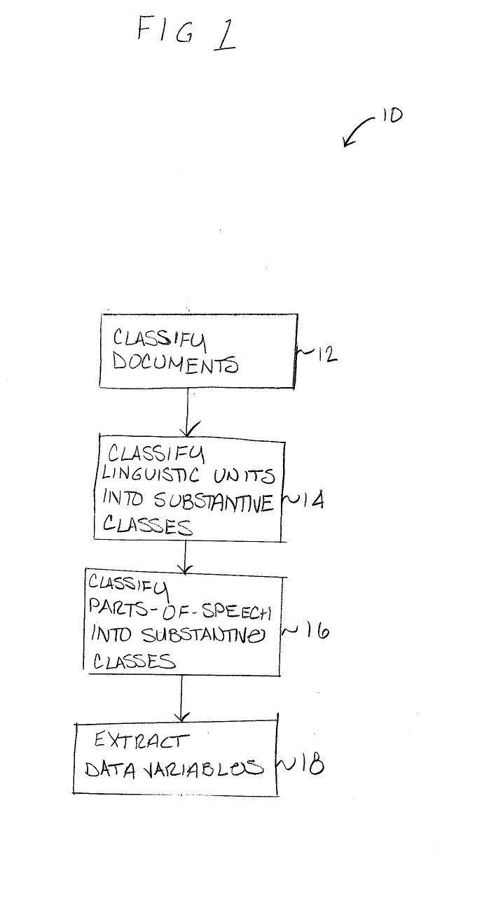

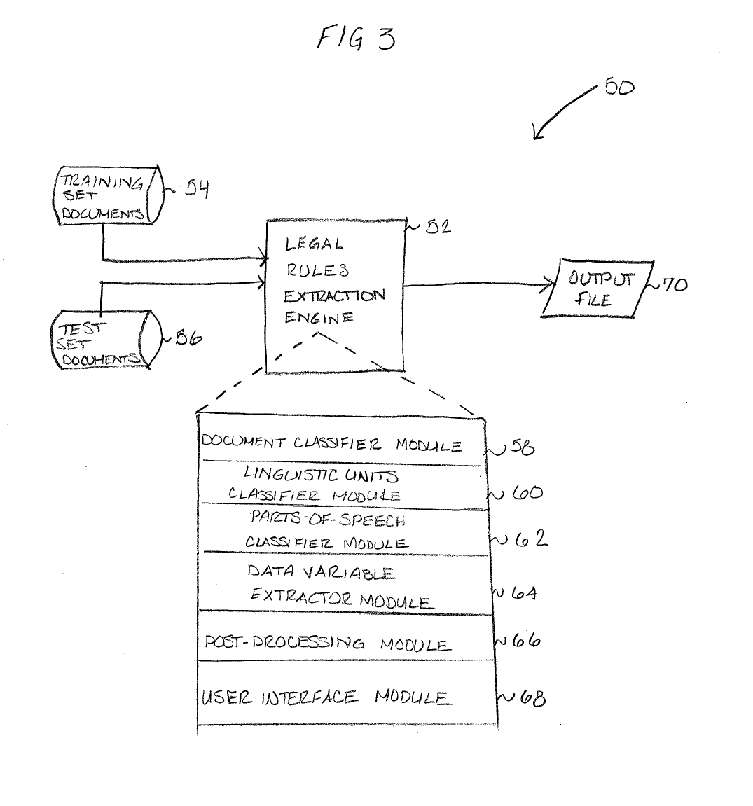

FIG. 1 is diagram showing a process carried out by a legal rule extraction engine in accordance with the present disclosure for extracting free-form textual rules and provisions from legal documents. The engine is shown in FIG. 3 (element 52), and includes a plurality of modules such as: a document classifier module 58, a linguistic units classifier module 60, a parts-of-speech classifier module 62, a data variable extractor module 64, a post-processing module 66, and a user interface module 68, which will be described in further detail below.

Referring to both FIGS. 1 and 3, the legal rules extraction engine 52 executes these modules in four phases: the document classifier module 58 classifies documents at 12 in FIG. 1, the linguistic units classifier module 60 classifies linguistic units into substantive classes at 14 in FIG. 1, the parts-of-speech classifier module 62 classifies parts-of-speech into substantive classes at 16 in FIG. 1, and the data variable extractor module 64 extracts data variables at 18 in FIG. 1.

In classifying documents at 12, the document classifier module 58 classifies raw text documents into different types of documents based on substantive (rather than only linguistic) distinctions in the schema of rules and provisions to be extracted. Thus, for example, the document classifier module 58 defines a document type such as a “certificate of incorporation,” and all certificates of incorporation share a common schema of rules and provisions, despite varying in their linguistic content and structure. The document classifier module 58 classifies the raw text documents into types through careful feature design and selection, rather than by only utilizing generic features such as “bag of words” term-frequency matrices. Thus, the document classifier module 58 can select features to uniquely identify each type of the document based on the document's identifying legal characteristics, regardless of linguistic content, structure or presentation. The document classifier module 58 utilizes these features with a labeled training set and probabilistic model to classify raw text documents into known types.

At 14, the linguistic units classifier module 60 classifies linguistic units into substantive classes. In doing so, at 14, the linguistic units classifier module 60 tokenizes each raw text document into a set of linguistic units such as paragraphs or sentences to identify linguistic units that contain the rules and provisions associated with the document schema. To identify unique features associated with each rule or provision, classification of linguistic units is often performed hierarchally in multiple stages, relying on substantive legal knowledge of the underlying document type. Thus, for example, a certificate of incorporation can be first divided into articles or sections, which are classified into different types of general topics, such as provisions governing the board of directors of the corporation. Conditional on the type of the parent article or section, it is straightforward to classify each paragraph or sentence found therein as containing one of the rules or provisions contained within the document. Such classification can often employ simple features such as term-frequency matrices, once this conditioning has taken place. To take an example, upon determining that a particular article in the certificate of incorporation governs the board of directors, it is straightforward for the computer to identify the sentence referring to procedures for the election of directors, as the vocabulary of this paragraph is generally unique within the article. The accuracy of this hierarchical method of classification relies on substantive understanding of the underlying structure of each document type.

At 16, the parts-of-speech classifier module 62 of legal rule extraction engine 52 classifies parts-of-speech into substantive classes. Conditional on the determination that the linguistic unit contains a particular rule or provision, the parts-of-speech classifier module 62 employs natural language parsing to extract the content of such rule or provision. In performing such parsing, the parts-of-speech classifier module 62 applies a simplified part-of-speech tagger to the linguistic unit to classify tokens into primary types such as nouns, verbs, prepositions and conjunctions. Then, the parts-of-speech classifier module 62 classifies these parts of speech into substantive types that depend on the underlying rule. Thus, for example, a noun phrase found in a sentence referring to procedures for the election of directors can be classified as referring to “directors” or “classes” (i.e., groups of directors elected in the same year). Such classification facilitates obtaining an abstract representation of the substantive elements of the linguistic unit.

At 18, the data variable extractor module 64 of the legal rule extraction engine 52 extracts data variables. The data variable extractor module 64 examines the empirical sequence of the substantive elements to extract the legal rule or provision. The degree of specificity in interpreting a given sequence depends on the type of rule or provision. For some, it is sufficient to simply identify the presence or absence of a particular term or modifier. For others, it is necessary to take into account more complex syntactical structure. The key difference from existing natural language parsers is that this syntactical structure is analyzed with substantive knowledge of the range of values that can be assigned to the legal rule or provision.

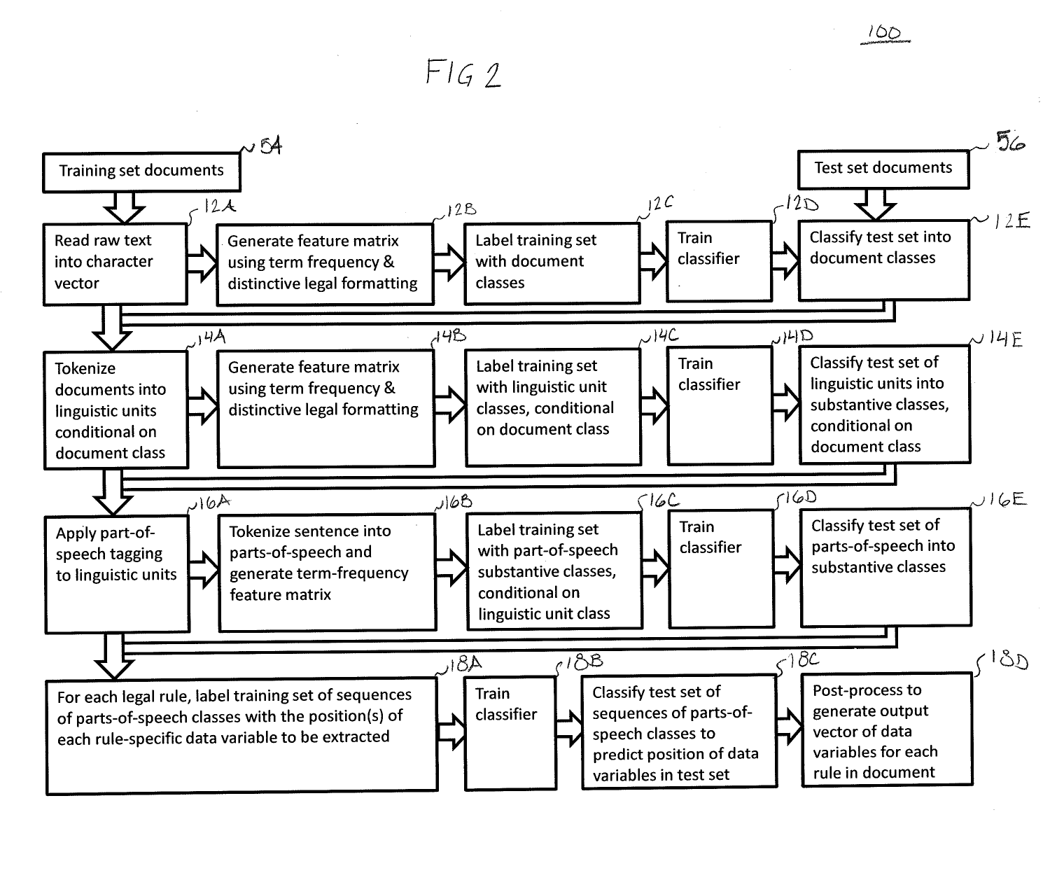

FIG. 2 is another (more detailed) diagram showing a process for extracting free-form textual rules and provisions from legal documents. More particularly, and as described in detail below, FIG. 2 shows a process performed by the legal rule extraction engine in carrying out at 12-18 shown in FIG. 1.

At 12A, the document classifier module 58 of the legal rule extraction engine 52 receives a training set document 54 reads raw text into a character vector. For example, a training set document 54 is read from a file system into a vector of characters in memory. 12A can be accomplished in any suitable programming language, and comprises reading a file contents into a string in memory.

In 12B, the document classifier module 58 generates a feature matrix using term frequency and distinctive legal formatting. In doing so, the document classifier module 58 preprocess the document to generate features suitable for document classification. This preprocessing can include removing items that generally have little predictive power. For example, the preprocessing can include: removing punctuation, removing numbers, removing stop words (e.g., a list of common English words, which generally have little predictive power with respect to document content), removing non-alphanumeric characters, and/or removing stemming words (e.g., utilizing the standard Porter stemmer).

After the preprocessing, the document classifier module 58 generates a document-term matrix to obtain an initial set of token-frequency features for document classification. A document-term matrix can be a two-dimensional matrix of data, where the columns represent unique terms (e.g., words), the rows represent documents, and the cells contain the frequency that each term appears in the document. A document-term matrix can be used with any linguistic unit, but the most common type of term utilized is words, bigrams (i.e., two-word combinations) or trigrams (i.e., three-word combinations). Thus, for example, a document-term matrix can appear as follows:

| | contract | terms | between | parties |
|---|---|---|---|---|
| Document 1 | 10 | 5 | 7 | 12 |
| Document 2 | 2 | 3 | 1 | 6 |
| Document 3 | 1 | 0 | 0 | 0 |

In addition to these term-frequency features, the document classifier module 58 generates document-specific features by taking advantage of substantive logic underlying distinctive legal formatting. Such formatting can reflect the requirements of a legal regulation or statute, or can simply reflect a widely utilized convention among lawyers. Thus, for example, a certificate of incorporation reflecting the establishment of a corporation is often characterized by the following formatting at the beginning of the document:

### ARTICLES OF INCORPORATION

### OF

### XYZ Corporation

The use the term “Articles of Incorporation,” set apart from other text, within the first few lines of a document reflects both the statutory requirement that this document be clearly delineated as such as well as common practice among lawyers to do so. It is possible to thus construct a binary feature reflecting whether such text and formatting is present, and this feature is likely to predictively identify a certificate of incorporation. An example of such an extended feature matrix would be as follows:

| | contract | terms | between | parties | AOI |
|---|---|---|---|---|---|
| Document 1 | 10 | 5 | 7 | 12 | 0 |
| Document 2 | 2 | 3 | 1 | 6 | 0 |
| Document 3 | 1 | 0 | 0 | 0 | 1 |

In this example, the column “AOI” is a binary variable set to 1 if the document contains the term “Articles of Incorporation,” set apart from other text in such a manner.

The use by the document classifier module 58 of substantive legal logic to identify predictive features for document classification represents a step forward from simple algorithms that solely use linguistic features such as document-term matrices. The novelty of this method is especially evident when combined with the subsequent features in the algorithm.

At 12C, the document classifier module 58 labels training set with document classes. In doing so, the document classifier module 58 takes a random sample of documents and manually labels these documents to facilitate document prediction using the feature matrix described previously. The term “labeling” can refer to specifying a class (e.g., “contract” or “certificate of incorporation”) for each document to which the document belongs. To perform such labeling, the document classifier module 58 determines a set of classes into which documents can be grouped.

A definition of these classes can turn on the set of substantive rules that will be classified in subsequent sections of the algorithm. Thus, for example, the document classifier module can delineate different types of legal contracts as different types of documents if those contracts have different sets of substantive rules to be extracted by the document classifier module 58 in subsequent stages.

An example of a vector of document classes follows, alongside the example feature matrix:

| | contract | terms | between | parties | AOI | Label |
|---|---|---|---|---|---|---|
| Document 1 | 10 | 5 | 7 | 12 | 0 | Contract |
| Document 2 | 2 | 3 | 1 | 6 | 0 | Misc. |
| Document 3 | 1 | 0 | 0 | 0 | 1 | Charter |

The document classifier module 58 can generate this vector of labels (typically referred to as the “y” vector in the machine learning literature) by having individuals read and choose the appropriate class for each document in the random sample of documents constituting the training set.

At 12D, the document classifier module 58 trains a classifier. After labeling the training set, this combination of feature matrix and labels are used as input a probabilistic classifier. Any type of probabilistic classification model can be utilized in this stage, including one that relies on a conditional independence assumption such as a Naive Bayes classifier, because the word count and distinctive legal features are likely close to conditionally independent of each other, thus allowing a classifier relying on a conditional independence assumption to perform well. To determine which classification model will be employed, the document classifier module can utilize a standard n-fold cross-validation procedure, which divides the labeled training set into several equally sized random samples (“folds”) and evaluates the performance of the model by training it on all but one fold and testing it on that fold. The model with the highest CV accuracy rate would be chosen.

In practice, the document classifier module 58 can utilize a Support Vector Machine classifier as such a model is well-suited to the nonlinear prediction inherent in word count frequencies. Thus, in the above example, a high word count for two terms—such as “contract” and “parties”—is likely to be far more predictive of a “contract” class than the predictive power of the “contract” and “parties” terms when considered additively.

At 12E, the document classifier module 58 classifies test documents into document classes. After training the classification model, the document classifier module applies the model to the remaining unlabeled documents to obtain predicted classes. The document classifier module 58 uses the feature matrix for unlabeled documents to predict a class for each document. The document classifier module 58 then utilizes the labeled and predicted classes for the entire set of documents in the process using the algorithm.

Classifying linguistic units into substantive classes occurs at 14A-14E. At 14A, the linguistic unit classifier module 60 tokenizes documents into linguistic units conditional on document class. In doing so, the linguistic unit classifier module 60 divides each classified document into a series of linguistic units depending on the class of the document. Thus, for example, a “contract” class document can be divided into paragraphs whereas a “corporate charter” can be divided into “articles” and “sections.” In performing division of a document into these linguistic units, the linguistic unit classifier module 60 can use simple regular expressions or character substrings. As an example, a new line character generally separates paragraphs, so occurrences of “\n” can be identified and utilized to split the document accordingly. As another example, the word “Article” or “Section” followed by a number, e.g., “Article 5” can be utilized to identify sections or articles. However, as these terms frequently appear in paragraphs making reference to articles and sections (not only as delineators of the article or section itself), it may be necessary to define a regular expression with blank line(s) following the article or section delineator.

If a regular expression is insufficient due to substantial variance in the presentation of linguistic units, the legal rule extraction engine can use machine learning. Using a machine learning algorithm can require identifying predictive features that facilitate classifying the beginning and end of linguistic units. Thus, for example, the presence or absence of a term such as “article” or “section” can be identified as a feature, along with formatting characteristics of the line to which it belongs. These can be utilized by the linguistic unit classifier module along with labeled training data to facilitate statistical prediction of the beginning and end of linguistic units.

At 14B, the linguistic unit classifier module 60 of the legal rule extraction engine 52 generates a feature matrix using term frequency and distinctive legal formatting. More particularly, the linguistic unit classifier module 60 generates a feature matrix for linguistic units to facilitate their prediction into substantive classes. The linguistic unit classifier module 60 generates the feature matrix for a predictive machine learning algorithm that will classify linguistic units (that have already been delineated) into classes with substantive meaning. For example, after the paragraphs of a contract have been identified, at 14B, the linguistic unit classifier module classifies these paragraphs into general sets of provisions based on the type of contract at issue. This can be similar to that taken by classic document summarization algorithms, whereby a particular linguistic unit (such as a paragraph) is identified as representing a certain type of information (e.g., a contract clause discussing liquidated damages), extracted and presented to the user.

To generate this feature matrix, the linguistic unit classifier module 60 can utilize term frequencies and distinctive legal formatting as at 12. However, the formatting is defined on the level of the linguistic unit. Thus, for example, in the case of contract paragraphs, one predictive feature can be the “header” text in bold underline located at the beginning of a paragraph, as the following example demonstrates:

Absence of Company Material Adverse Effect. Except as disclosed in the Filed Company SEC Documents or in the Company Disclosure Letter, since the date of the most recent financial statements included in the Filed Company there shall not have been any event, change, effect or development that, individually or in the aggregate, has had . . . .

In the above example, the content and formatting characteristics of the header text can serve as predictive features for classifying the type of contract provision. Again, these linguistic unit features are generated conditional on having classified the type of legal document at issue. Thus, for certain types of linguistic units in certain types of documents, there may be no header text; for these linguistic units, other features would be identified.

At 14C, the linguistic unit classifier module 60 labels the training set with linguistic unit classes, conditional on document class. This can be similar to 12C. A random sample of linguistic units is selected to serve as a training set, and this training set is labeled with the substantive classes for this class of document.

At 14D and 14E, linguistic unit classifier module 60 of the legal rule extraction engine 52 trains a classifier and classifies the test set of linguistic units into substantive classes, conditional on document class. This part of the process can be similar to 12D and 12E described above. After labeling the training set, the linguistic unit classifier module 60 uses the combination of feature matrix and labels as input in a probabilistic classifier. A classification model is trained, conditional on the type of document, and applied to the unlabeled test set of linguistic units among documents to predict substantive classes for each linguistic unit. These labeled and predicted linguistic units are utilized in the next stage for part-of-speech classification.

Classifying parts-of-speech into substantive classes occurs at 16A-16E. At 16A, the parts-of-speech classifier module 62 applies a part-of-speech tagging to linguistic units. To extract legal rules from the free-form text in a linguistic unit (i.e., paragraph), the parts-of-speech classifier module 62 identifies which parts of speech are found within that linguistic unit. For example, a part-of-speech tagger can be applied to the text of the linguistic unit. The parts-of-speech classifier module 62 can use a variety of part-of-speech tagging algorithms, and can use the algorithm with the highest accuracy through a cross-validation procedure. After applying the part-of-speech tagger, each word in the sentence can be assigned a part-of-speech tag.

At 16B, the parts-of-speech classifier module 62 tokenizes a sentence into parts-of-speech and generates a term-frequency feature matrix. After the words in the linguistic unit have been assigned a part-of-speech tag, the parts-of-speech classifier module 62 performs a substantive classification of these parts-of-speech-tagged words based on each of the underlying legal rules to be extracted. Thus, for each legal rule contained within a linguistic unit of a particular type, a feature matrix can be generated for the words of each sentence, including term frequencies along with each word's part-of-speech tag. This feature matrix—where each “document” is an individual word—is used by a dependency-aware classification algorithm such as a Hidden Markov Model or conditional random fields classifier.

At 16C, the parts-of-speech classifier module 62 labels the training set with part-of-speech substantive classes, conditional on linguistic unit class. To classify these sequences of part-of-speech-tagged words, the parts-of-speech classifier module generates a training set by labeling the words within a random sample of linguistic units with the correct substantive classes. As an example, below is a linguistic unit consisting of the following sentence:

The board of directors shall be divided into three classes.
The part-of-speech tagger applies a part-of-speech tag to each word. The following is the example output from the Stanford part-of-speech tagger:
The/DT board/NN of/IN directors/NNS shall/MD be/VB divided/VBN into/IN three/CD classes/NNS
Also, a feature matrix is generated for each word, a simplified version is as follows:

| | board | directors | divided | into | three | classes | POS |
|---|---|---|---|---|---|---|---|
| word 1 | 1 | 0 | 0 | 0 | 0 | 0 | NN |
| word 2 | 0 | 1 | 0 | 0 | 0 | 0 | NNS |
| word 3 | 0 | 0 | 1 | 0 | 0 | 0 | VBN |
| word 4 | 0 | 0 | 0 | 1 | 0 | 0 | IN |
| word 5 | 0 | 0 | 0 | 0 | 1 | 0 | CD |
| word 6 | 0 | 0 | 0 | 0 | 0 | 1 | NNS |

Each of these words is then labeled with a substantive class based on the legal rule at issue, i.e., the number of directors, as demonstrated by the following example:

| | substantive class |
|---|---|
| word 1 | board |
| word 2 | director |
| word 3 | divide |
| word 4 | <none> |
| word 5 | <none> |
| word 6 | number |
| word 7 | class |

This additional layer of substantive classification is advantageous for two reasons. First, different words can be used to express the same underlying substantive concept. Second, many words-POS combinations will not map onto the substantive classes seemingly suggested by the words. Thus, for example, the term “class” need not always map onto the underlying substantive class of a “class” of directors. This classification might depend on whether the term “class” was preceded by a number, as in the prior example. As explained at 16D, this makes sequential dependency advantageous to take into account when classifying these substantive terms.

At 16D, the parts-of-speech classifier module 62 trains the classifier. As described above, at 16C, the parts-of-speech classifier module 62 generated a training set of word-POS combinations with labeled substantive classes. At 16D, the parts-of-speech classifier module 62 trains a classification model to permit classifying unlabeled word-POS combinations, conditional on the class of the enclosing linguistic unit. The parts-of-speech classifier module 62 takes dependency into account, as the word-POS mappings to substantive classes depends greatly on the order of word-POS combinations in the linguistic unit.

A conditional random fields (CRF) classifier model can be used by the parts-of-speech classifier module for this classification stage. The CRF is well-suited for taking into account dependency in the sequence of features and classes, which is advantageous for determining the correct substantive classes that each POS-word combination represents.

At 16E, the parts-of-speech classifier module 62 classifies a test parts-of-speech into substantive classes. In doing so, the model previously trained is applied to unlabeled text in linguistic units to classify each word-POS combination into a substantive class. This classification is performed conditional on the type of the linguistic unit.

Extraction of data variables occurs at 18A-18D. In 18A, the data variable extractor module 64 uses sequences of substantive term classes as predictors for positions of rule-specific data variables to be extracted. Thus, given a particular sequence of substantive term classes, the data variable extractor module 64 can identify a series of substantive term positions that correspond to the data variables of interest to be extracted. To continue the example from the prior section, the sentence “The board of directors shall be divided into two classes” is transformed by the data variable extractor module into the following sequence of substantive classes:

board director divide number class
Conditional on this sequence, the only data variable of interest in this example—the number of classes of directors—is located at the fourth position. But a different sequence would lead to a different position for the data variable. Consider the following sequence:
class divide board director number
Conditional on this sequence, the data variable of interest is located at the fifth position.

Thus, the data variable extractor module 64 functions by obtaining an abstract representation of the word-POS terms in the substantive classes obtained, and utilizing this abstract representation to determine the positions of the substantive data variables of interest. These data variables can be quantitative—e.g., “three” in the case of three classes—or simply binary, i.e., reflecting the presence or absence of a particular rule in a linguistic unit.

At 18B, the data variable extractor module 64 trains the classifier similarly to 12D, 14D and 16D described above. At 18C, the data variable extractor module 64 classifies a test set of sequences of parts-of-speech classes to predict positions of data variables in test sets, similarly to 12E, 14E and 16E described above. At 18D, the post processing module 66 of the legal rule extraction engine 52 performs a post-process to generate to a user interface module 68 an output vector of data variables for each rule in a document.

FIG. 3 is a system diagram 50 showing inputs, outputs, and components of the legal rules extraction engine 52. More specifically, the legal rules extraction engine 52 electronically receives one or more sets of training set documents 54 from a training set document database and one or more sets of test set documents 56 from a test set document database. These sets of training set documents and test set documents are used by the legal rules extraction engine 52, as discussed above.

As shown in FIG. 3, the legal rules extraction engine 52 includes the document classifier module 58, the linguistic units classifier module 60, the parts-of-speech classifier module 62, the data variable extractor module, the post-processing module 66, and the user interface module 68. The document classifier module 58, a linguistic units classifier module 60, a parts-of-speech classifier module 62, a data variable extractor module use the training set documents and test set documents to train and test the legal rules extraction engine 52, as described above. As described above, the document classifier module 58 classifies documents, the linguistic units classifier module 60 classifies linguistic units into substantive classes, the parts-of-speech classifier module 62 classifies parts-of-speech into substantive classes, and the data variable extractor module 64 extracts data variables. The post-processing module 66 then generates one or more output vectors of data variables for each rule in the document. The post-processing module 66 can then send the one or more output vectors of data variables to the user interface module 68. The user interface module 68 can then display the one or more output vectors of data variables to a user through a user interface generated by the user interface module 68. The process performed by the modules 58-68 are discussed above in connection with FIGS. 1-2.

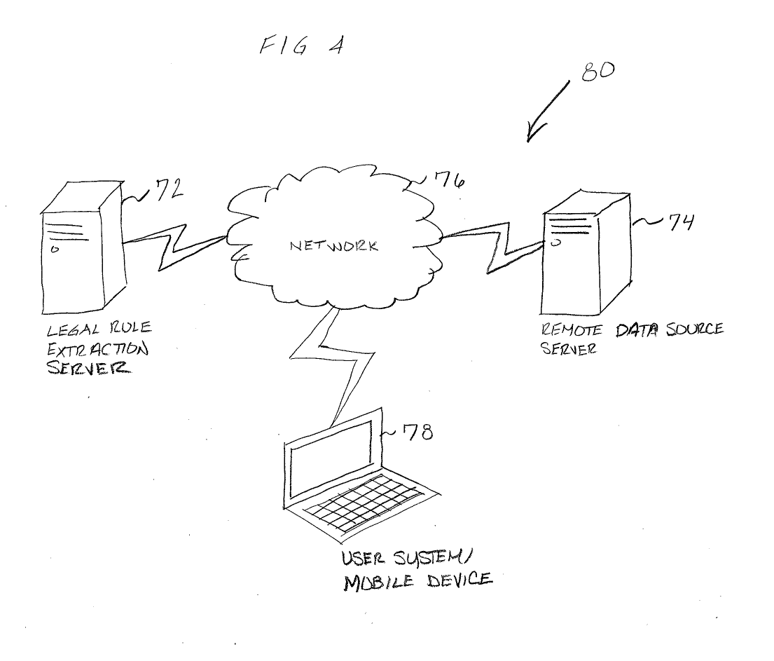

FIG. 4 is a diagram 80 showing sample hardware components for implementing the present invention. A legal rules extraction server 72 can be provided, and can include a database (stored on the system or located externally therefrom) and the legal rules extraction engine stored therein and executed by the legal rules extraction server 72. The legal rules extraction server 72 can be in electronic communication over a network 76 with a remote data source server 74, which can have a database (stored on the system or located externally therefrom) digitally storing training set documents 54, test set documents 56, etc. The remote data source server 74 can comprise one or more government entities, such as those storing Securities and Exchange Commission (SEC) records and filings. Of course, other types of legal rules data can be provided without departing from the spirit or scope of the present invention.

Both the legal rules extraction server 72 and the remote data source server 74 can be in electronic communication with one or more user systems/mobile devices 78. The systems can be any suitable servers (e.g., a server with a microprocessor, multiple processors, multiple processing cores) running any suitable operating system (e.g., Windows by Microsoft, Linux, UNIX, etc.). Network communication can be over the Internet using standard TCP/IP and/or UDP communications protocols (e.g., hypertext transfer protocol (HTTP), secure HTTP (HTTPS), file transfer protocol (FTP), electronic data interchange (EDI), dedicated protocol, etc.), through a private network connection (e.g., wide-area network (WAN) connection, emails, electronic data interchange (EDI) messages, extensible markup language (XML) messages, file transfer protocol (FTP) file transfers, etc.), or using any other suitable wired or wireless electronic communications format. Also, the systems can be hosted by one or more cloud computing platforms, if desired. Moreover, one or more mobile devices (e.g., smart cellular phones, tablet computers, etc.) can be provided. Additionally, it is noted that the various modules disclosed herein could be programmed using any suitable programming language, including, but not limited to, Java, C, C++, C#, Python, Go, etc., without departing from the spirit or scope of the present disclosure.

Despite the shared reference to extraction, text summarization methods such as those employed by eBrevia differ fundamentally from the disclosed system and method. For example, the output format of the disclosed system and method differs from that of text summarization: text summarization extracts blocks of classified raw text from a full-text document; it thus “summarizes” a document by generating more raw text. For example, eBrevia extracts the “assignment” paragraph from a full-text contract and places the entire paragraph in a text box labeled as such. The disclosed system and method does not merely generate raw text but rather a series of binary or quantitative variables that reflect the underlying substantive contract terms. Thus, if the disclosed system and method were to be applied to an assignment paragraph in a contract, it can generate a series of binary variables which specified whether each side was eligible to assign the contract.

The disclosed system and method builds on the fundamental insight that while legal documents vary greatly from a linguistic standpoint, the substantive rules and provisions that they seek to establish are generally consistent across certain types of documents. As such, provided is a supervised method that utilizes detailed, domain-specific substantive knowledge of different types of legal documents to generate structured datasets of substantively meaningful rules and provisions.

Having thus described the disclosed system and method in detail, it is to be understood that the foregoing description is not intended to limit the spirit or scope thereof. It will be understood that the embodiments of the present disclosure described herein are merely exemplary and that a person skilled in the art can make many variations and modification without departing from the spirit and scope of the invention. All such variations and modifications, including those discussed above, are intended to be included within the scope of the disclosure.

What is claimed is:

1. A method for autonomously extracting legal rules from documents by a computer system, the computer system comprising a machine learning legal rules extraction engine, a user interface, and a memory, the method comprising:
electronically receiving, by the legal rules extraction engine, a document;
processing the document using a first trained model executed by the legal rules extraction engine to classify the document into a document class;
processing the document using a second trained model executed by the legal rules extraction engine to extract rules within the document conditional on the document class identified by the first trained model;
extracting a plurality of data variables from the document by processing the classified features in the document using a third trained model executed by the legal rules extraction engine;
generating by the legal rules extraction engine an output vector based on the plurality of data variables; and
displaying the output vector by the legal rules extraction engine at the user interface.

2. The method of claim 1, wherein the legal rules extraction engine includes a document classifier module, a linguistic units classifier module, a parts-of-speech classifier module, a data variable extractor module, and a post-processing module.

3. The method of claim 2, wherein the first trained module comprises the document classifier module, and the method further comprising classifying, by the document classifier module, documents based on substantive distinctions in schema of rules and provisions.

4. The method of claim 3, further comprising generating, by the document classifier module, a document-term matrix to obtain a set of token-frequency features for document classification.

5. The method of claim 4, wherein the second trained module comprises the linguistic units classifier module, and the method further comprising classifying, by the linguistic units classifier module, linguistic units into substantive classes by tokenizing each raw text document into a set of linguistic units and identifying linguistic units that contain rules and provisions associated with document schema.

6. The method of claim 5, wherein the second trained module comprises the parts-of-speech classifier module, and the method further comprising applying, by the parts-of-speech classifier module, a part-of-speech tagger to the linguistic units to classify tokens into primary types.

7. The method of claim 6, wherein the parts-of-speech classifier module includes a conditional random fields classifier to evaluate dependency in a sequence of features and classes.

8. A non-transitory computer-readable medium having computer-readable instructions stored thereon which, when executed by a computer system, cause the computer system to perform the steps of:
electronically receiving, by the legal rules extraction engine, a document;
processing the document using a first trained model executed by the legal rules extraction engine to classify the document into a document class;
processing the document using a second trained model executed by the legal rules extraction engine to extract rules within the document conditional on the document class identified by the first trained model;
extracting a plurality of data variables from the document by processing the classified features in the document using a third trained model executed by the legal rules extraction engine;
generating by the legal rules extraction engine an output vector based on the plurality of data variables; and
displaying the output vector by the legal rules extraction engine at the user interface.

9. The computer-readable medium of claim 8, wherein the legal rules extraction engine includes a document classifier module, a linguistic units classifier module, a parts-of-speech classifier module, a data variable extractor module, and a post-processing module.

10. The computer-readable medium of claim 9, wherein the first trained module comprises the document classifier module, and the method further comprising classifying, by the document classifier module, documents based on substantive distinctions in schema of rules and provisions.

11. The computer-readable medium of claim 10, further comprising generating, by the document classifier module, a document-term matrix to obtain a set of token-frequency features for document classification.

12. The computer-readable medium of claim 11, wherein the second trained module comprises the linguistic units classifier module, and the method further comprising classifying, by the linguistic units classifier module, linguistic units into substantive classes by tokenizing each raw text document into a set of linguistic units and identifying linguistic units that contain rules and provisions associated with document schema.

13. The computer-readable medium of claim 12, wherein the second trained module comprises the parts-of-speech classifier module, and the method further comprising applying, by the parts-of-speech classifier module, a part-of-speech tagger to the linguistic units to classify tokens into primary types.

14. The computer-readable medium of claim 13, wherein the parts-of-speech classifier module includes a conditional random fields classifier to evaluate dependency in a sequence of features and classes.

15. A system for autonomously extracting legal rules from documents using machine learning, comprising:
a computer system comprising a machine learning legal rules extraction engine, a user interface, and a memory;
a legal rules extraction engine executed by the computer system, the engine:
processing the document using a first trained model executed by the legal rules extraction engine to classify the document into a document class;
processing the document using a second trained model executed by the legal rules extraction engine to extract rules within the document conditional on the document class identified by the first trained model;
extracting a plurality of data variables from the document by processing the classified features in the document using a third trained model executed by the legal rules extraction engine;
generating by the legal rules extraction engine an output vector based on the plurality of data variables; and
displaying the output vector by the legal rules extraction engine at the user interface.

16. The system of claim 15, wherein the legal rules extraction engine includes a document classifier module, a linguistic units classifier module, a parts-of-speech classifier module, a data variable extractor module, and a post-processing module.

17. The system of claim 16, wherein the first trained module comprises the document classifier module, and the legal rules extraction engine further comprising classifying, by the document classifier module, documents based on substantive distinctions in schema of rules and provisions.

18. The system of claim 17, the legal rules extraction engine further comprising generating, by the document classifier module, a document-term matrix to obtain a set of token-frequency features for document classification.

19. The system of claim 18, wherein the second trained module comprises the linguistic units classifier module, and the legal rules extraction engine further comprising classifying, by the linguistic units classifier module, linguistic units into substantive classes by tokenizing each raw text document into a set of linguistic units and identifying linguistic units that contain rules and provisions associated with document schema.

20. The system of claim 19, wherein the second trained module comprises the parts-of-speech classifier module, and the legal rules extraction engine further comprising applying, by the parts-of-speech classifier module, a part-of-speech tagger to the linguistic units to classify tokens into primary types.

21. The system of claim 20, wherein the parts-of-speech classifier module includes a conditional random fields classifier to evaluate dependency in a sequence of features and classes.

22. A system for autonomously extracting legal rules from documents, the system comprising a legal rules extraction engine, a user interface, and a memory, the memory containing a set of instructions that, when executed by the legal rules extraction engine, cause the legal rules extraction engine to:
electronically receive a document;
classify the document into a document class of a plurality of document classes;
extract rules within the document conditional on the document class;
extract a plurality of data variables from the document by processing the extracted rules;
generate an output vector based on the plurality of data variables; and
display at the user interface the output vector.

23. The system of claim 22, wherein the legal rules extraction engine includes a document classifier module, a linguistic units classifier module, a parts-of-speech classifier module, a data variable extractor module, and a post-processing module.
